(19) United States
(12) Patent Application Publication
(10) Pub. No.: US 2021/0034109 A1
(43) Pub. Date: Feb. 4, 2021

(54) INFORMATION HANDLING SYSTEM FLEXIBLE DISPLAY BEZEL

(71) Applicant: Dell Products L.P., Round Rock, TX (US)

(72) Inventors: Christopher A. Torres, San Marcos, TX (US); Kevin M. Turchin, Cedar Park, TX (US); Enoch Chen, Wenshan District (TW); Weijong Sheu, Austin, TX (US)

(73) Assignee: Dell Products L.P., Round Rock, TX (US)

(21) Appl. No.: 16/530,373

(22) Filed: Aug. 2, 2019

(51) Int. Cl. G06F 1/16; G06F 3/14

(52) U.S. Cl. CPC G06F 1/1652; G06F 1/1681; G06F 3/14; G06F 1/1616; G06F 1/1686

(57) ABSTRACT

An information handling system processes information with processing components disposed in housing portions rotationally coupled by a hinge and presents the information as visual images at a flexible display film disposed over the hinge to fold when the hinge rotates the housing portions from an open to a closed position. A bezel fits over the outer perimeter having a rigid portion and a flexible portion. The bezel flexible portion fits over the flexible display film at the hinge to support display film folding having managed torsional and compressive forces.

### BACKGROUND OF THE INVENTION

### Field of the Invention

The present invention relates in general to the field of portable information handling systems, and more particularly to an information handling system flexible display bezel.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

Recently, flexible display films made organic light emitting diode (OLED) pixels have become more common in portable information handling systems. OLED display films are capable of folding and may be included in a convertible information handling system with one flexible display film disposed across a hinge that rotationally couples separate housing portions so that an unfolded configuration provides a tablet with a single display surface. With a flexible display, a convertible system may be rotated ninety degrees open to a clamshell configuration so that half of the display surface presents visual images while the other half accepts typed inputs, such as at a virtual keyboard presented on the display. By eliminating the integrated keyboard, the system thickness and weight are reduced to improve mobility. In a closed configuration, the housing portions rotate to fold the display film over the hinge, providing a reduced footprint and protection for storage and mobility.

One difficulty with the use of a flexible display film that folds is that the display film can suffer damage if the fold angle becomes too extreme or if tensile and/or compressive stresses are created at the fold. Since the circumference of the inner housing surface becomes smaller during a fold relative to the circumference of the outer housing surface, housing movement relative to the display film about the fold is generally compensated in some manner. In addition, the fold angle about the hinge generally provides some space for the display film to take a natural form without pressure from hinge movement.

Another difficulty with a flexible display that folds about a hinge is that the outer surface of the flexible display typically has some support provided by a more rigid material that will prevent damage from touches at the flexible display. For instance, along the perimeter of the information handling system a bezel is typically included that covers and protects the perimeter of the flexible display. A number of components are often integrated with the bezel, such as a camera, microphone, proximity sensor, antennae, etc. . . . . The bezel thus has contradictory goals of protecting the display film and integrated components while also supporting folding of the flexible display without applying tensile and compressive forces at the folded portion of the flexible display. The bezel tends to impact the appearance and aesthetics of the information handling system so that an overly cumbersome bezel material detracts from the end user experience.

### SUMMARY OF THE INVENTION

Therefore, a need has arisen for a system and method which supports and protects a flexible display integrated in an information handling system while providing flexibility in a folding region.

In accordance with the present invention, a system and method are provided which substantially reduce the disadvantages and problems associated with previous methods and systems for integrating a flexible display across a hinge that rotationally couples information handling system housing portions to each other. A bezel fits around an outer perimeter of a flexible display with a rigid portion over the housing portions and a flexible portion over the hinge. The flexible portion protects the flexible display at folding of the hinge to manage torsional and compressive forces from the folding.

More specifically, an information handling system processes information with components disposed in housing portions rotationally-coupled by a hinge, such as a processor and memory. A flexible display film, such as a plastic organic light emitting diode (POLED) display, presents the information as visual images at a display surface that extends across the housing portions to fold at the hinge. A bezel couples to the housing portions and over the hinge about a perimeter of the POLED display film to protect the edge of the POLED display film. The bezel includes a flexible portion that folds with folding of the display in response to closing of the housing portions about the hinge. For example, a flexible silicon material, such as a liquid silicon rubber, integrates with a rigid material, such as poly(methyl methacrylate) (PMMA) disposed over polycarbonate, to cover, protect and align the flexible display film and related components. In one alternative embodiment, the bezel includes a rolled stainless steel aligned vertical with the folding motion of the hinge to leverage the flexing characteristics of rolled stainless steel.

The present invention provides a number of important technical advantages. One example of an important technical advantage is that an information handling system that rotates housing portions to fold a flexible display has protection provided along the perimeter of the flexible display with a bezel flexible portion folding at the hinge over the flexible display to manage torsional and compressive forces at the flexible display. The bezel protects against infiltration of impurities at the information handling system upper surface perimeter and at the flexible display film fold region with the bezel flexible portion conforming to the fold form in the closed position.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an upper perspective exploded view of a portable information handling system having a flexible display protected at its perimeter by a bezel having rigid and flexible portions;

FIGS. 2A, 2B, 2C, 2D and 2E depict a portable information handling system having a bezel with a PMMA rigid portion and a flexible silicon portion;

FIGS. 3A, 3B and 3C depict a portable information handling system having a bezel with a silicon rubber perimeter;

FIGS. 4A, 4B and 4C depict a portable information handling system having a liquid silicon rubber flexible portion; and

FIG. 5 depicts a side cutaway view of a portable information handling system having a bezel that incorporates peripheral components.

### DETAILED DESCRIPTION

A portable information handling system integrating a flexible display film protects the flexible display film perimeter with a bezel having a rigid portion and a flexible portion aligned at the folding position of the flexible display film. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

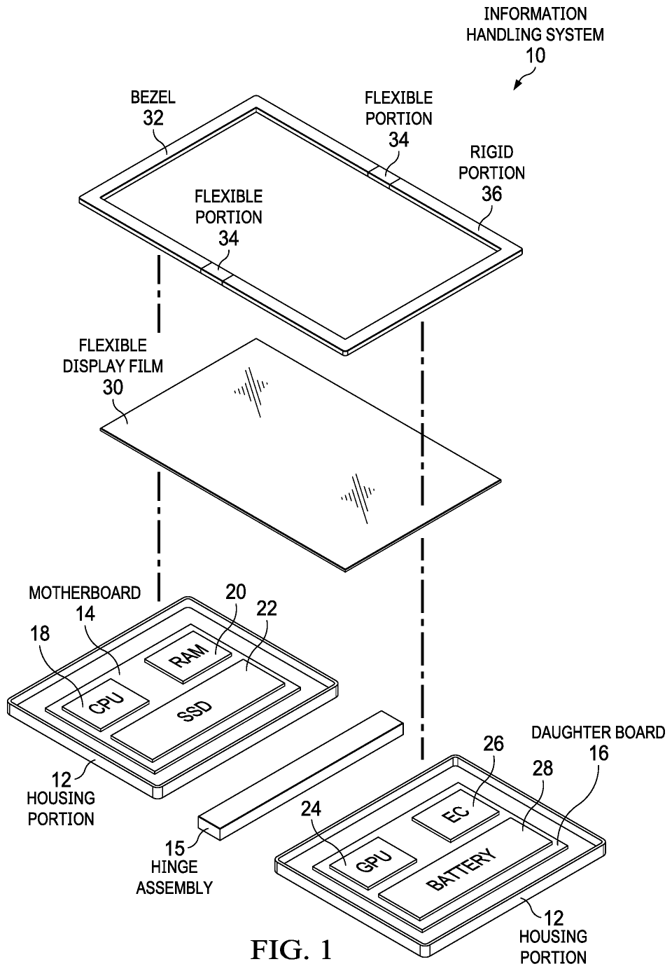

Referring now to FIG. 1, an upper perspective exploded view depicts a portable information handling system 10 having a flexible display film 30 protected at its perimeter by a bezel 32 having a rigid portion 36 and a flexible portion 34. In the example embodiment, information handling system 10 has first and second housing portions 12 rotationally coupled by a hinge assembly 15. Each housing portion 12 contains processing components that cooperate to process information. In the example embodiment, one housing portion 12 contains a motherboard 14 that integrates wirelines for communication between a central processing unit (CPU) 18, random access memory (RAM) 20 and persistent storage provided by a solid state drive (SSD) 22. The opposing housing portion 12 contains a daughterboard 16 that integrates wirelines for communication between a graphics processing unit (GPU) 24 and embedded controller 26. A flexible cable interfaces motherboard 14 and daughterboard 16 across hinge assembly 15, such as is disclosed in U.S. patent application Ser. No. ______, entitled “Synchronized Dual Axis Pivot Hinge,” by Christopher A. Torres, et al., which is incorporated herein in its entirety as if fully set forth. For instance, CPU 18 executes an operating system and applications retrieved from SSD 22 to RAM 20 by pre-boot code executed on embedded controller 26 at system power up. GPU 24 receives information from CPU 18 that defines visual images and processes the information to create pixel values that generate the visual images at flexible display film 30. Power to operate the processing components is provided from an internal battery 28.

Housing portions 12 rotate about hinge assembly 15 between the depicted flat configuration and a folded configuration that folds flexible display film 30 at the location of hinge assembly 15. For instance, each housing portion 12 rotates ninety degrees relative to hinge assembly 15 to a closed position having opposing sides of flexible display film 30 in proximity to each other. To support folding, flexible display film 30 is, for example, a plastic organic light emitting diode (POLED) display having a flexible plastic substrate. The portions of flexible display film 30 that extend over top of housing portions 12 remain in the same plane as the housing portion 12 upper surface plane so that folding does not occur; however, the portions of flexible display film 30 over hinge assembly 15 folds with a radius defined by hinge assembly 15, as explained in Tones et al., incorporated herein, to avoid compressive and tensile stresses. A bezel 32 couples to housing portions 12 and hinge assembly 15 to protect the perimeter of flexible display film 30 while supporting folding of flexible display film 30 at hinge assembly 15 without compressive or tensile forces applied by bezel 32 at flexible display film 30. To provide this support, bezel 32 integrates a rigid portion 36 that aligns over housing portions 12 and a flexible portion 34 that aligns over hinge assembly 15.

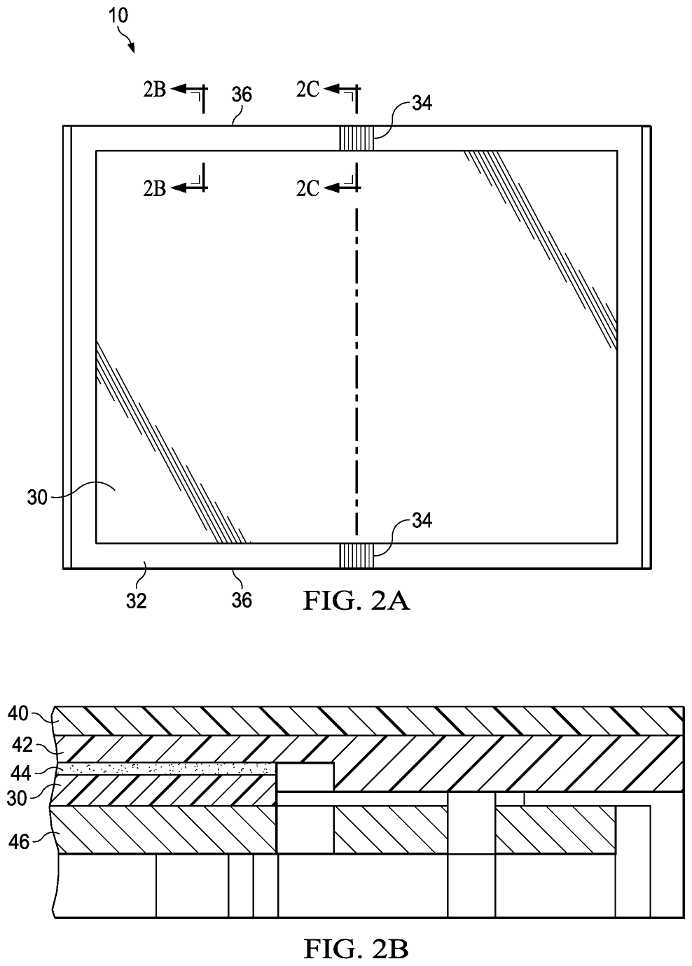

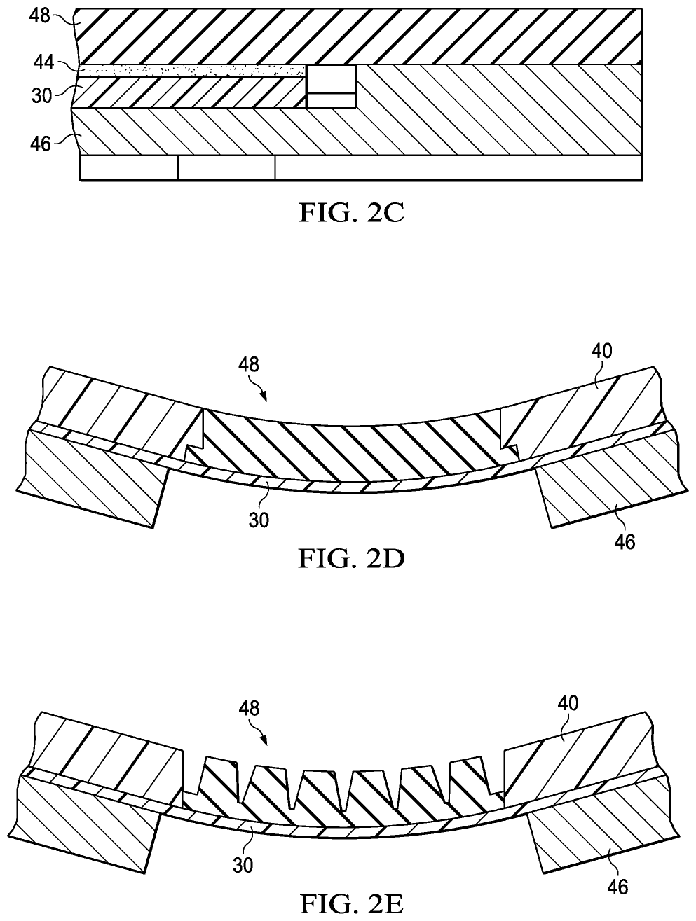

Referring now to FIGS. 2A, 2B, 2C, 2D and 2E, a portable information handling system 10 is depicted having a bezel 32 with a poly(methyl methacrylate) (PMMA) rigid portion 36 and flexible silicon portion 34. FIG. 2A depicts a first location of a cross sectional view 2B shown in FIG. 2B and taken at rigid portion 36 and a second location of a cross sectional view 2C shown in FIG. 2B and taken at flexible portion 34. In the example embodiment, FIG. 2B depicts layered rigid materials that fit over the perimeter of flexible display 30 with an outer layer of PMMA 40 of 0.4 mm thickness attached to layers below by an adhesive, such as 0.1 mm of Tesa4972. To hide the mechanics along the perimeter of flexible display film 30, PMMA layer 40 may have a printed black upper surface with some clear portions disposed over the location of sensors, such as cameras, ambient light sensors, proximity sensors, etc. . . . . Below PMMA layer 40, a polycarbonate structure 42 provides additional rigidity and an upper surface to which PMMA layer 40 adheres. In one alternative embodiment, PMMA layer 40 and polycarbonate structure 42 may be formed as a single structure, such as with a multi-shot injection molding process.

As illustrated by FIG. 2B, polycarbonate layer 42 forms a ledge under which flexible display film 30 aligns. Between polycarbonate layer 42 and flexible display film 30, a polyurethane cellular foam cushion 44, such as layer of PORON, aids in absorption and dissipation of compressive and tensile stress. In turn, flexible display film 30 is supported by a set frame 46 that extends underneath to provide support against touches or other pressures applied to the upper surface of flexible display film 30. In the example embodiment, polycarbonate layer 42 includes a member that extends downward and couples to set frame 46 to hold bezel 32 in a fixed location relative to flexible display film 30. In various embodiments, alternative materials may be used for bezel 32 in the place of polycarbonate, especially where an upper PMMA layer 40 provides a positive aesthetic appearance.

FIG. 2C depicts an example of a flexible portion 34 construction that aids in managing stress at the folding region of flexible display film 30. A silicon rubber material layer 48, such as with a durometer of 50A, of 0.9 mm thickness is used over top of flexible display film 30. A polyurethane cellular foam cushion layer 44, such as PORON is disposed between silicon material layer 48 and flexible display film 30 to aid cushioning of compressive and tensile stress applied at folding of flexible display film 30. Set frame 46 supports flexible display film 30, including through any folding motion that is translated through rotation about hinge assembly 15. Silicon rubber layer 48 couples to polyurethane cellular foam cushion layer 44 and set frame 46 with an adhesive, such as 0.1 mm Tesa4972.

FIGS. 2D and 2E depict alternative surface formations that may be included in silicon rubber material layer 48 to aid in dissipation of tensile and compressive forces associated with folding of flexible display film 30. FIG. 2D illustrates a silicon rubber material layer 48 of relatively uniform thickness that tends to experience compression on an inner circumference of a fold and tension at an outer circumference of a fold. In one embodiment, the natural curvature of silicon rubber material layer 48 tends to align with that expected of a flexible display film 30 so that compressive and tensile forces are minimized. FIG. 2E depicts silicon rubber material layer 48 formed to integrate plural spaced slots that provide room for compression of each slot member at the inner circumference of a fold. By providing room for compression about the slots, any compressive or tensile forces that might translate to flexible display 30 will be minimized since rubber silicon material layer 48 provides relatively less resistance against lateral pressures compared with the uniform material of FIG. 2D.

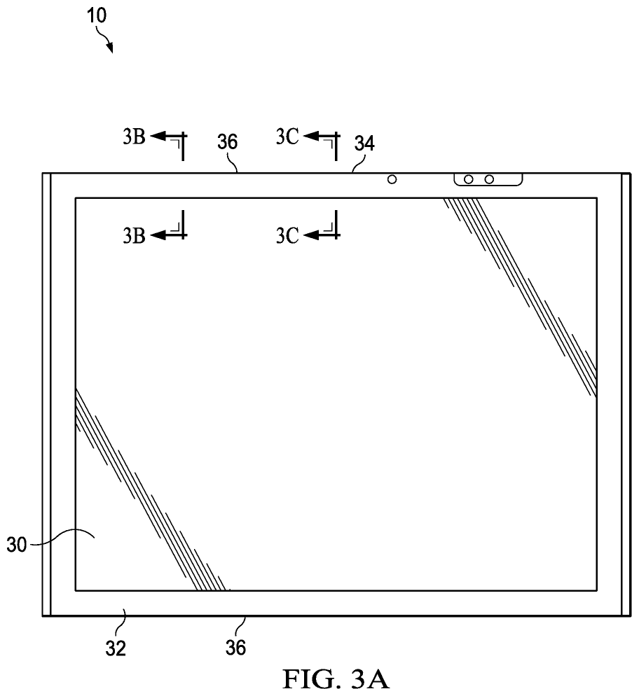

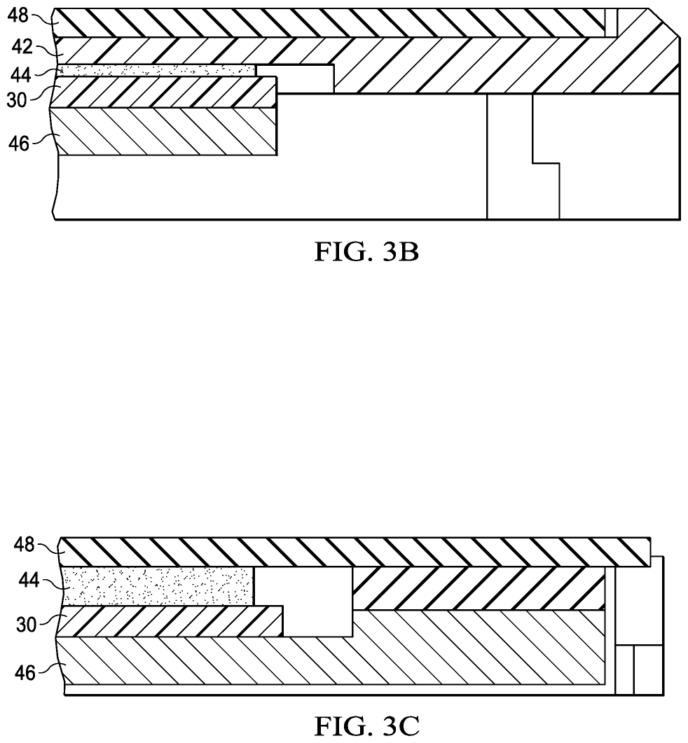

Referring now to FIGS. 3A, 3B and 3C, a portable information handling system is depicted having a bezel 32 with silicon rubber perimeter. For example, a silicon rubber sheet of 50A durometer and 0.4 mm thickness is cut to have an inner perimeter that fits over the outer perimeter of flexible display film 30 and an outer perimeter that aligns with the edges of housing portions 12. As an alternative, a liquid silicon rubber may be used to form bezel 32. In one embodiment, bezel 32 may have the slot members depicted in FIG. 2E located at flexible portion 34 and a uniform thickness at rigid portions 36. FIG. 3A depicts a cross section view of rigid portion 36 at 3B shown in greater detail in FIG. 3B, and a cross section view of flexible portion 34 at 3C shown in greater detail in FIG. 3C.

FIG. 3B depicts a cutaway view of rigid portion 36 with a contiguous silicon rubber material layer 48 of 0.4 mm thickness disposed at an outer surface and coupled to an underlying layer of polycarbonate 42 of 0.5 mm thickness with a 0.1 mm thick adhesive, such as Tesa4972. A 0.2 mm polyurethane cellular foam cushion layer 44 is disposed between polycarbonate layer 42 and flexible display film 30, which supported by set frame 46. FIG. 3C depicts the bezel 32 over flexible portion 34 with a consistent thickness of silicon rubber material 48 of 0.4 mm disposed over polyurethane cellular foam cushion layer 44 having 0.7 mm thickness. Essentially, the thickness of polyurethane cellular foam cushion layer 44 is increased to replace the thickness of polycarbonate found in rigid portion 36. Outside the perimeter of flexible display film 30, an additional strip of rubber material cushions the intersection of silicon rubber material layer 48 and set frame 46. In various embodiments, various thickness of the silicon rubber material layer may be used to obtain desired flexible display film folding characteristics.

In one alternative embodiment, silicon rubber material 48 may be replaced with a single thin stainless steel sheet bezel, such as rolled stainless steel having a thickness of 0.03 mm. The stainless steel may be cut to fit around an entire perimeter of flexible display film 30 or to just couple over the flexible portion 34 of bezel 32. The rolling process used to create thin stainless steel provides excellent yielding properties in the direction vertical to rolling, which is aligned with the folding direction of flexible region 34.

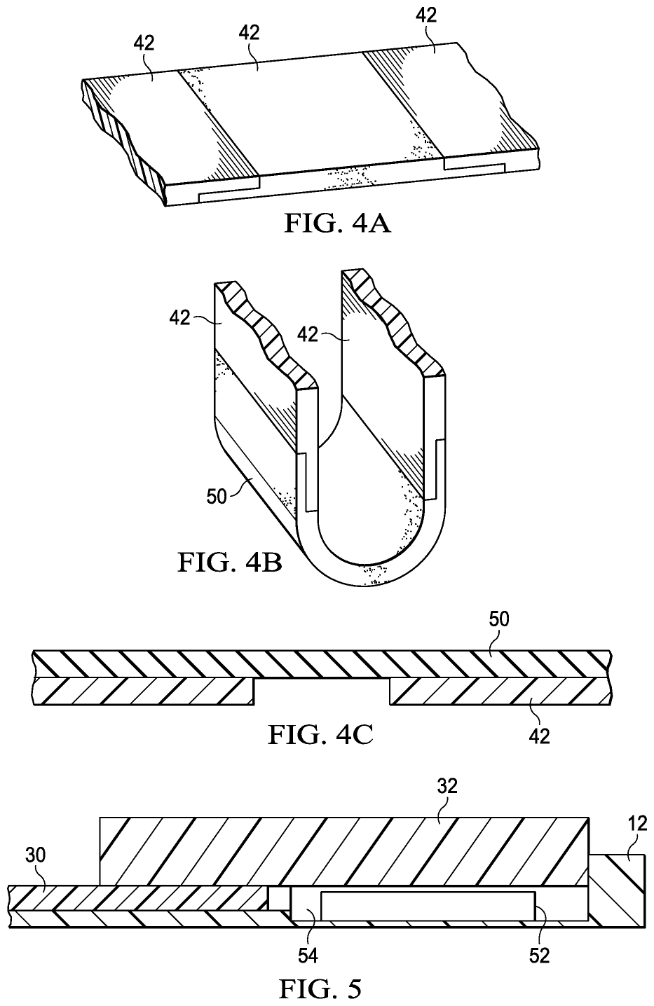

Referring now to FIGS. 4A, 4B and 4C depict a portable information handling system 10 having a liquid silicon rubber flexible portion 50. FIG. 4A depicts a liquid silicon rubber material 50 at a flexible portion 34 of bezel 32 that couples on each of opposing sides to a polycarbonate structure 42. In the example embodiment, both polycarbonate material 42 and liquid silicon rubber material 50 of bezel 32 have a thickness of 1.0 mm with an overlap on each side having 0.6 mm of polycarbonate and 0.4 mm of liquid silicon rubber 50. The overlap region of liquid silicon rubber material 50 is on the outer circumference of the flexible portion 34 of bezel 32, as depicted by FIG. 4B. As shown in FIG. 4A, approximately three to five millimeters of liquid silicon rubber material 50 at the inner circumference remains in plane with polycarbonate structure 42 at the transition of flexible portion 34 and rigid portion 36. FIG. 4C shows an alternative embodiment in which liquid silicon rubber material 50 has a uniform thickness with an open region between opposing polycarbonate structure 42.

The liquid silicon rubber material 50 may be used in various embodiments with other types materials describe above. For instance, a PMMA layer may be used over rigid portion 36 and intersecting with flexible liquid silicon rubber material 50, or may fit over or under the liquid silicon material in the rigid portion 36 where liquid silicon rubber extends around the complete perimeter of bezel 32.

Referring now to FIG. 5, a side cutaway view depicts a portable information handling system 10 having a bezel 32 that incorporates peripheral components 52. Bezel 32 and rigid portion 36 includes a cavity 54 that defines a location for placement of peripheral components 52, such as a camera or an antenna. For instance, a cavity is formed in polycarbonate material and then covered with a transparent material, such as a PMMA layer. Bezel 32 form and cavities aid in alignment of flexible display film 30 and components located along its perimeter for ease of manufacture.

Although the present invention has been described in detail, it should be understood that various changes, substitutions and alterations can be made hereto without departing from the spirit and scope of the invention as defined by the appended claims.

1. An information handling system comprising:
first and second housing portions;
processing components disposed in the first and second housing portions and cooperating to process information;
a hinge rotationally coupling the first and second housing portions to each other;
a flexible display film disposed over the first and second housing portions and the hinge. The flexible display film interfaced with the processing components and operable to present the information as visual images; and
a bezel disposed about a perimeter of the flexible display, the bezel having a rigid portion and a flexible portion, the flexible portion disposed over the hinge to flex in response to hinge rotation for protection of the flexible display film over the hinge.

2. The information handling system of claim 1 wherein:
the rigid portion comprises an outer layer of poly(methyl methacrylate) (PMMA) disposed over polycarbonate; and
the flexible portion comprises flexible silicon.

3. The information handling system of claim 2 wherein the flexible silicon is formed having plural spaced slots disposed to compress the spaced slots at rotation from an open to a closed configuration.

4. The information handling system of claim 1 wherein the polycarbonate forms to have an opening sized to accept a component under the PMMA.

5. The information handling system of claim 4 wherein the component comprises a camera.

6. The information handling system of claim 1 wherein:
the rigid portion comprises an outer layer of flexible silicon disposed over polycarbonate; and
the flexible portion comprises flexible silicon.

7. The information handling system of claim 6 wherein the flexible silicon comprises liquid silicon rubber.

8. The information handling system of claim 1 wherein:
both the rigid portion and flexible portion comprise a contiguous stainless steel sheet manufactured by rolling; and
the flexible portion comprises a portion in the direction vertical to rolling.

9. The information handling system of claim 1 further comprising a polyurethane cellular foam cushion disposed between the bezel and the flexible display film.

10. A method for manufacture of a portable information handling system, the method comprising:
rotationally coupling first and second housing portions with a hinge;
disposing a flexible display film over the first and second housing portions and the hinge;
rotating the first and second housing portions about the hinge between an open position having the flexible display film in a flat configuration and a closed position having the flexible display film folded at the hinge; and
protecting a perimeter of the flexible display film with a bezel coupled to the housing portions over the perimeter, the bezel having a rigid portion and a flexible portion, the flexible portion disposed over the hinge to flex in response to the rotating the hinge.

11. The method of claim 10 wherein the protecting the perimeter further comprises:
manufacturing the bezel rigid portion with an outer layer of poly(methyl methacrylate) (PMMA) disposed over polycarbonate; and
manufacturing the bezel flexible portion with a flexible silicon.

12. The method of claim 11 wherein the manufacturing the bezel rigid portion further comprises a multi-shot injection of PMMA and polycarbonate.

13. The method of claim 12 wherein the manufacturing the bezel flexible portion further comprises a multi-shot injection of the flexible silicon with the PMMA and polycarbonate.

14. The method of claim 10 further comprising forming the bezel flexible portion to have plural spaced slots disposed to compress together at rotation from the open to the closed configuration.

15. The method of claim 10 wherein the protecting the perimeter further comprises:
manufacturing the bezel with rolled stainless steel; and
coupling the bezel over the hinge to fold in a direction vertical to a rolling direction of the stainless steel.

16. The method of claim 10 further comprising:
disposing a polyurethane cellular foam cushion between the bezel and the flexible display film.

17. The method of claim 16 wherein the bezel flexible portion comprises liquid silicon rubber that extends to the rigid bezel portion.

18. An information handling system bezel comprising:
a rigid portion including polycarbonate having an interior circumference sized to cover an outer perimeter of a flexible display film; and
a flexible portion including flexible silicon sized to cover the outer perimeter of the flexible display film at a folding portion, the rigid portion integrated into a contiguous piece with the flexible portion.

19. The information handling system bezel of claim 18 further comprising:
a PMMA material layer disposed over the polycarbonate; and
a camera integrated in a cavity formed in the polycarbonate.

20. The information handling system of claim 19 further comprising:
a rolled stainless steel layer having rolling characteristics aligned with a vertical axis;
wherein the rolling characteristics align vertical to rolling over the flexible display film folding portion.
